(19) United States
(12) Patent Application Publication
(10) Pub. No.: US 2024/0208857 A1
(43) Pub. Date: Jun. 27, 2024

(54) Glass Modification Process Usable With CVD Diamond Deposition

(71) Applicant: AKHAN Semiconductor, Inc., Gurnee, IL (US)

(72) Inventors: Maria Maugeri, Westmont, IL (US); Adam Kahn, Tiburon, CA (US); Emie Schirmann, Lake Zurich, IL (US); John Thode, Lake Zurich, IL (US); Debarati Mukherjee, Libertyville, IL (US)

(21) Appl. No.: 18/535,511

(22) Filed: Dec. 11, 2023

Related U.S. Application Data
(60) Provisional application No. 63/434,262, filed on Dec. 21, 2022.

(51) Int. Cl. C03C 17/22; C03C 21/00

(52) U.S. Cl. CPC C03C 17/22; C03C 21/002; C03C 2218/152

(57) ABSTRACT

A diamond system includes a glass substrate having a first and a second side, wherein the second side is chemically modified through ion substitution. CVD deposited diamond layer can be present on the first side or additional sides or edges.

### RELATED APPLICATION

This application claims the priority benefit of U.S. Provisional Patent Application No. 63/434,262, filed on Dec. 21, 2022, which is hereby incorporated by reference in its entirety.

### FIELD OF THE INVENTION

This invention is generally related to systems and methods for diamond coating of chemically modified or ion substituted glass using chemical vapor deposition (CVD). Typically, at least one side of a transparent glass substrate is chemically modified to increase glass hardness and durability, either before or after diamond deposition.

### BACKGROUND

Diamond films or coatings can be used for protecting optical systems, coatings for consumer applications such smartphone or watch displays, coatings for tooling or mechanical parts, coatings for chemical protection, or in electrical or semiconductor applications. Advantageously, diamond films provide increased hardness, scratch resistance, water resistance, and various unique electrical properties. However, commercially practical diamond films or coatings remain limited due to cost and time required for depositing usefully thick diamond coatings on glass substrates.

Another problem with diamond coatings on glass substrates follows from CVD thermal processing of chemically modified glasses. To increase durability and reduce cracking chances, glass can be chemically modified by immersion in a salt bath. For example, glass can be immersed in a bath of potassium nitrate at a temperature greater than 300° C. Sodium ions present on the glass surface are replaced by potassium ions from the bath. Since potassium ions are larger than sodium ions, sodium ion replacement introduces a large stress into the glass surface that protect the glass from breakage, scratches and thermal shocks. As another example, aluminosilicate glass containing aluminum oxide, at levels between 20% and 40% can be treated in a molten salt solution at around 400° C. Again, there can be an exchange of smaller sodium ions for larger potassium ions, providing a greater surface strength.

Unfortunately, reheating chemically modified glass in a CVD chamber for diamond deposition can result in potassium or other ion diffusion from the glass surface to throughout the glass, eliminating or reducing the chemical modification of the glass surface. What is needed are glass structures and processing techniques that provide or allow for chemically modified glass with deposited diamond coatings.

### SUMMARY

Disclosed herein is a new and improved system and method for a diamond coating using CVD systems. In some embodiments, a diamond coated glass structure can include a glass substrate having a first and a second side, wherein the second side is chemically modified through ion substitution. A CVD deposited diamond layer can be provided on the first side.

In some embodiments, the CVD deposited diamond layer comprises less than 20% SP2 carbon.

In some embodiments, the CVD deposited diamond layer comprises multiple diamond layers.

In some embodiments, the CVD deposited diamond layer comprises an ultrananocrystalline diamond layer on a nanocrystalline diamond layer.

In some embodiments, the substrate has a dimension of at least one centimeter.

In some embodiments, ion substitution further comprises replacement of at least some sodium ions with potassium ions.

In some embodiments, ion substitution further comprises replacement of at least some ions on the second side to a penetration depth of less than 100 microns.

In some embodiments, a diamond coated glass structure can include a glass substrate having a first and a second side, wherein the first and the second side are chemically modified through ion substitution and penetration depth differs between the first and second sides. A CVD deposited diamond layer can be provided on at least one of the first side and the second side.

In some embodiments, a diamond coated glass structure can include a glass substrate having an opposing first and a second side and four edges, wherein the first and the second side and four edges are chemically modified through ion substitution, and wherein penetration depth of the first side differs from at least one of the second side and the four edges. A CVD deposited diamond layer can be provided on the first side.

In some embodiments, a method of manufacturing a diamond coated glass structure can include providing a glass substrate having a first and a second side. A diamond layer is CVD deposited on the first side and after CVD diamond deposition, the second side is chemically modified through ion substitution.

In some embodiments, a method of manufacturing a diamond coated glass structure can include providing a glass substrate having a first and a second side. The first and second sides can be chemically modified through ion substitution. After chemically modifying the first and second side, a CVD diamond layer can be deposited on the first side.

In some embodiments, a method of manufacturing a diamond coated glass structure can include providing a glass substrate having a first and a second side;
the first and second sides are chemically modified for a first time by ion substitution and a diamond layer can be CVD deposited on the first side. After CVD diamond deposition, for a second time both the first and second sides of the glass substrate are chemically modified through ion substitution. In some embodiments, only the second side is chemically modified through ion substitution.

Other systems, methods, aspects, features, embodiments and advantages of the system and method disclosed herein will be, or will become, apparent to one having ordinary skill in the art upon examination of the following drawings and detailed description. It is intended that all such additional systems, methods, aspects, features, embodiments and advantages be included within this description, and be within the scope of the accompanying claims.

### BRIEF DESCRIPTION OF THE DRAWINGS

It is to be understood that the drawings are solely for purpose of illustration. Furthermore, the components in the figures are not necessarily to scale, emphasis instead being placed upon illustrating the principles of the system disclosed herein. In the figures, like reference numerals designate corresponding parts throughout the different views.

FIG. 1A is an exemplary schematic diagram of a glass substrate having one side being diamond coated, and then treated to chemically modify sides or edges not coated with diamond;

FIG. 1B is an exemplary schematic diagram of a glass substrate that is chemically modified and then at least partially coated with diamond;

FIG. 1C is an exemplary schematic diagram of a glass substrate that is optionally chemically modified, then at least partially coated with diamond, and then further treated to chemically modify sides or edges already coated with diamond;

FIG. 1D is an exemplary schematic diagram of a glass substrate having opposing top and bottom sides and four edges that is chemically modified;

FIG. 1E is an exemplary graph indicating penetrance depth of substituting ions into a glass substrate;

FIG. 2A is an exemplary block diagram of an embodiment of a method for fabricating a chemically modified glass with one side being diamond coated such as illustrated with respect to FIG. 1A;

FIG. 2B is an exemplary block diagram of an embodiment of a method for fabricating a chemically modified glass with one side being diamond coated such as illustrated with respect to FIG. 1B; and

FIG. 2C is an exemplary block diagram of an embodiment of a method for fabricating a chemically modified glass with at least one side being diamond coated such as illustrated with respect to FIG. 1C.

### DETAILED DESCRIPTION

The following detailed description, which references to and incorporates the drawings, describes and illustrates one or more specific embodiments. These embodiments, offered not to limit, but only to exemplify and teach, are shown and described in sufficient detail to enable those skilled in the art to practice what is claimed. Thus, for the sake of brevity, the description may omit certain information known to those of skill in the art.

As used in this disclosure, the terms “layer”, “film”, and “coated” can be interchangeably used, and refer to thin deposited, chemically formed, grown materials, or otherwise situated materials on a substrate that can itself be a layer, film or coating. Diamond layers or films can include intrinsic diamond, diamond-like material, or diamond with small amounts of graphite or other materials. Diamond lattice structure can be selectively modified and can include provision of varying sp2/sp3 carbon materials positioned through selective seeding or etch, nucleation or growth process parameters including gas composition, pressure, and temperature among other parameters, selective laser annealing, particle bombardment or doping, or use of laser pulse to grow diamond. Modification of diamond layers or films by oxygen termination, hydrogen termination, chlorine or fluorine functionalization are additional embodiments.

The diamond structure and manufacturing method described herein can incorporate systems and methods previously disclosed and described in U.S. Patent Publication No. 2013/0026492, by Adam Khan, published on Jan. 31, 2013; U.S. Pat. No. 8,354,290, issued to Anirudha Sumant, et al, on Jan. 15, 2013; U.S. Pat. No. 8,933,462, issued to Adam Khan on Jan. 13, 2015; U.S. Patent Publication No. 2015/0206749, by Adam Khan, published on Jul. 23, 2015; and U.S. Patent Publication No. 2015/0295134, by Adam Khan, et al, published on Oct. 15, 2015, all of which are fully incorporated herein by reference.

In one embodiment, chemical modification can include subjecting diamond coated glass to an ion exchange process. As used herein, the term “ion exchange” or “ion substitution” is understood to mean that the glass is capable of being chemically modified by ion exchange processes that are known to those skilled in the art. Such ion exchange processes include, but are not limited to, treating the glass with a solution containing ions having a larger ionic radius than that of the ions that are present in the glass surface, replacing the smaller ions with the larger ions. In one embodiment of this process, at least some ions of a first element in a surface region in the glass article are exchanged with ions of a second element, wherein each of the ions of the second element has an ionic radius that is greater than that of the ion of the first element that is being replaced. In one embodiment, the first and second elements are alkali metals. The replacement of sodium (Na+ ions) with potassium (K+ ions) is a non-limiting example of such an ion exchange. Alternatively, other alkali metal ions having larger atomic radii, such as rubidium or cesium, could replace smaller alkali metal ions in the glass. In another embodiment, the smaller alkali metal ions could be replaced by silver (Ag+) ions. In some embodiments, additional elements such as Li+, Rb+, Cs+, Cd2+, Zn2+ or Cu+/Cu2+ can be used. As will be understood, ion exchange can be done before or after diamond coating, and multiple ion exchange events can occur during glass processing.

Ion exchange may be carried out using those methods known in the art and described herein. Depending on ion penetrance depth and other characteristics, chemical modification by ion exchange of a glass substrate can result in glass strengthening, hardening, or both. In one embodiment, the glass is immersed in a molten salt bath comprising an alkali metal salt such as, for example, potassium nitrate (KNO3), for a predetermined time period to achieve ion exchange. In some embodiments, the glass substrate can be chemically modified in a single ion exchange step. In some embodiments, the glass substrate is immersed in a molten salt bath containing a salt of the larger alkali metal cation. In some embodiments, the molten salt bath contains or consists essentially of salts of the larger alkali metal cation. In some embodiments single ion exchange process may take place at a temperature below 600° C., while in other embodiments the temperature can be between 275° C. and 550° C. for a time sufficient to achieve the desired ion depth penetrance (which in some embodiments can be increased as thickness of glass increases, and in some embodiments can be between 5 and 300 microns).

In another embodiment, a glass substrate can be chemically modified in a two-step or dual ion exchange method. In the first step of this process embodiment, the glass substrate is ion exchanged in the first molten salt bath. After completion of the first ion exchange, the glass can be optionally diamond coated, and then immersed in additional ion exchange baths (e.g., a second ion exchange bath). Additional or second ion exchange baths can have the same composition as the first ion exchange bath. Alternatively, additional or second ion exchange baths can have different compositions and/or operated at differing immersion time lengths and temperatures than the first ion exchange bath.

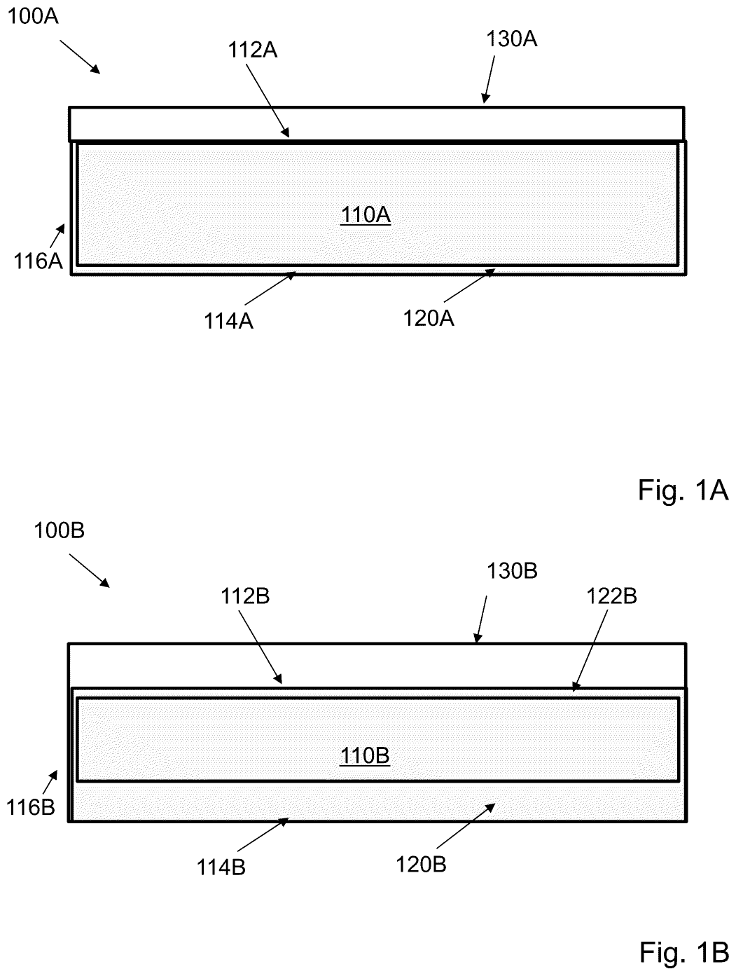

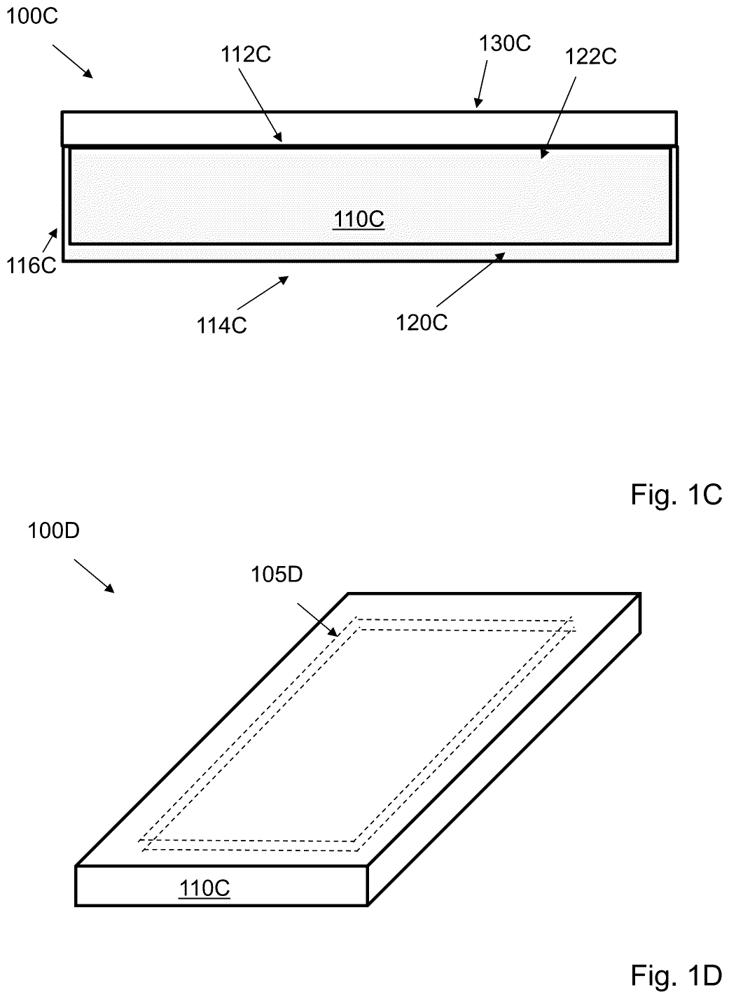

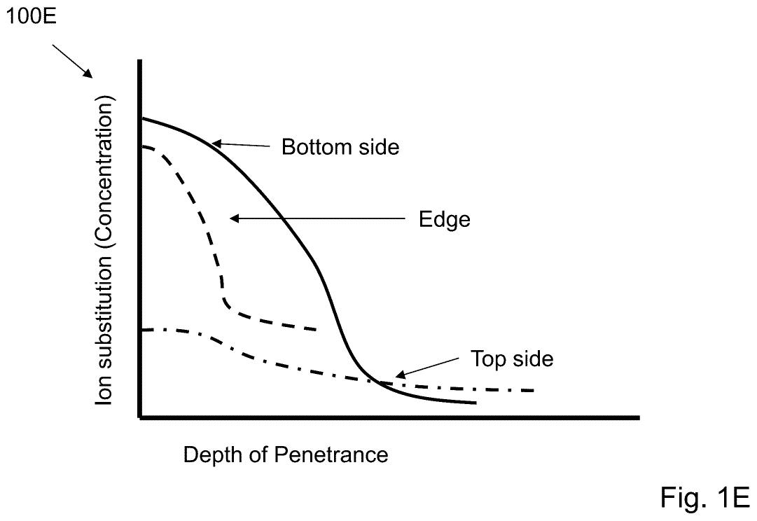

As illustrated with respect to FIG. 1A, a system and method provided herein allow manufacture of a partially diamond coated glass structure 100A. The glass structure 100A includes a glass substrate 110A having a first side 112A, a second side 114A, and an edge 116A. In one embodiment, the second side 114A and edge 116A are chemically modified through ion substitution, with significant substitution occurring to a depth of less than 100 microns along the second side 114A and edge 116A, indicated as ion penetrance region 120A in FIG. 1A. Advantageously, chemical modification of the glass substrate 110A can occur after deposition of a diamond layer 130A on the first side 112A. Depending on ion penetrance depth and other characteristics, chemical modification by ion substitution of a glass structure can result in glass strengthening, hardening, or both.

In another embodiment illustrated with respect to FIG. 1B, a system and method provided herein allow manufacture of a partially diamond coated glass structure 100B. The glass structure 100B includes a glass substrate 110B having a first side 112B, a second side 114B, and an edge 116B. In one embodiment, the first side 112B, second side 114B, and edge 116B are chemically modified through ion substitution, with significant substitution occurring to a depth of less than 100 microns along the first side 112B, second side 114B, and edge 116B, indicated as ion penetrance region 120B in FIG. 1B. In this embodiment, chemical modification of the glass substrate 110B can occur before deposition of a diamond layer 130B on the first side 112V. Due to ion movement possible under thermal conditions required for diamond deposition, the ion penetrance region 120B depth will significantly differ between the first side 112B and a second side 114B. In some embodiments, changes in ion concentration or ion depth in the ion penetrance region 120B on the second side 114B can be limited by contacting second side 114B with a cooling tool during diamond deposition.

FIG. 1C is an exemplary schematic diagram of a glass substrate that is optionally chemically modified, then at least partially coated with diamond, and then further treated to chemically modify sides or edges already coated with diamond. The glass structure 100C includes a glass substrate 110C having a first side 112C, a second side 114C, and an edge 116C. In one embodiment, the first side 112C, second side 114C, and edge 116C are chemically modified through ion substitution, with significant substitution occurring to a depth of less than 100 microns along the first side 112C, second side 114V, and edge 116V, indicated as ion penetrance region 120C in FIG. 1C. In this embodiment, chemical modification of the glass substrate 110C can occur before deposition of a diamond layer 130C on the first side 112V. Due to ion movement possible under thermal conditions required for diamond deposition, the ion penetrance region 120C depth will significantly differ between the first side 112C and a second side 114C. In some embodiments, changes in ion concentration or ion depth in the ion penetrance region 120C on the second side 114C can be limited by contacting second side 114C with a cooling tool during diamond deposition. Alternatively or in addition, after deposition of diamond layer 130C, the glass structure 100C can be placed in a second or multiple ion exchange bath for further chemical modification. In some embodiments, chemical modification by dopant implant through the diamond layer 130C can be used to increase ion concentration or penetrance below the diamond layer 130C.

FIG. 1D is an exemplary schematic diagram of a glass substrate 110C having opposing top and bottom sides and four edges with corners that is chemically modified. After ion exchange for chemical modification, a region between a penetrance depth 105D (indicated by dotted line) and the respective top, bottom, edges, and corners is chemically modified.

FIG. 1E is an exemplary graph 100E indicating penetrance depth 105E for substituting ions into a glass substrate with a top diamond coating such as described with respect to FIGS. 1A-D. In one embodiment, ion exchange results in a penetrance profile where the ion exchange surface layer for a top, bottom, or edge of a glass substrate having a depth of at least 20 microns is formed in the glass. In alternative embodiments, penetrance depth is at least 5, 10, 20, 30, or 50 microns into the glass. As is clear from the graph and the discussion with respect to FIGS. 1B and 1C, depth of ion penetrance differs depending on presence or absence of a diamond layer. In this embodiment, ion penetrance through the top layer with a diamond coating is significantly less than edge or bottom penetrance.

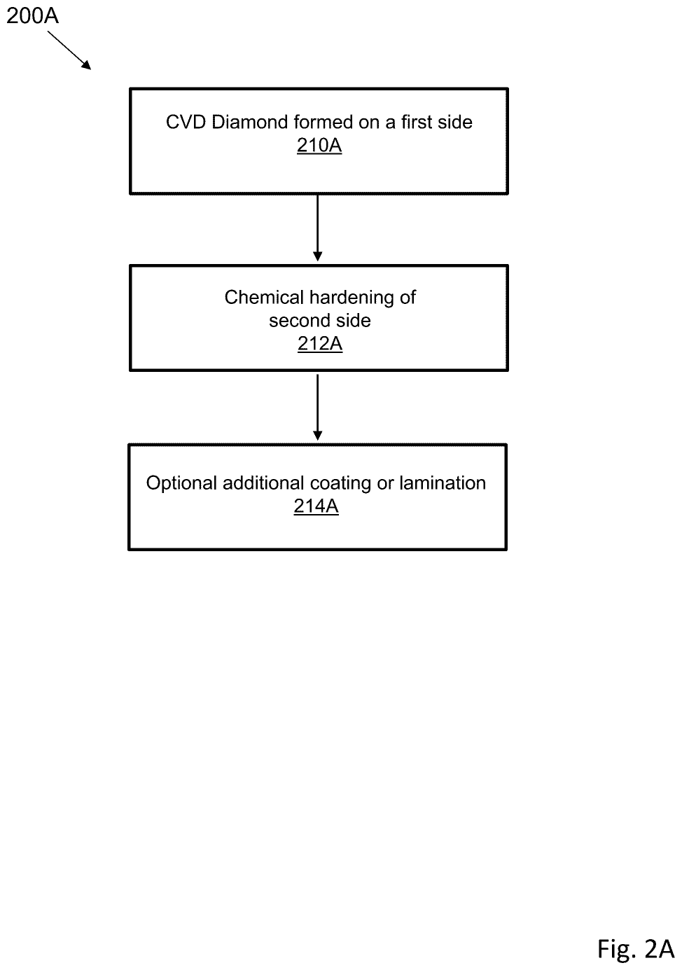

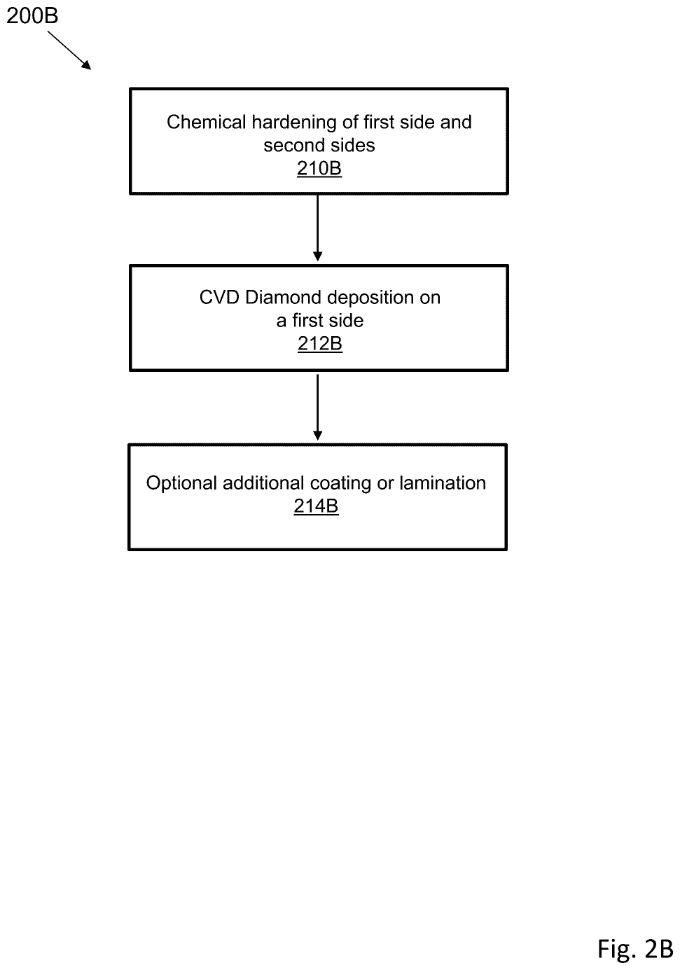

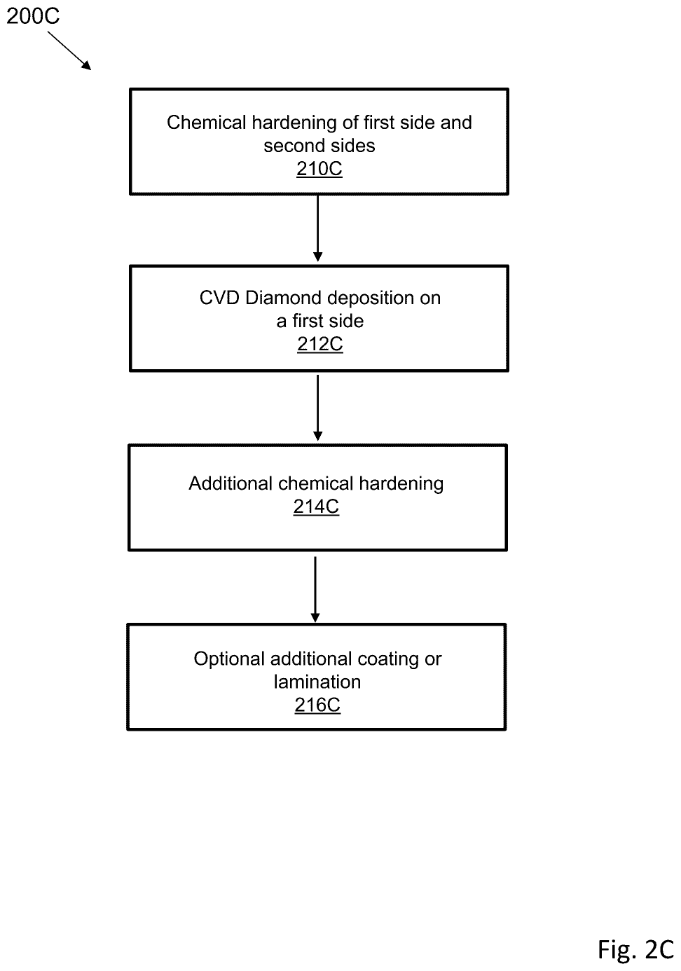

FIG. 2A is an exemplary block diagram of an embodiment of a method for fabricating a chemically modified glass substrate structure with one side being diamond coated such as illustrated with respect to FIG. 1A. In this embodiment, in a first step 210A CVD diamond is formed on at least a first side. The first side can be one of a top, bottom, edge, or corner. In addition to a first side, in some embodiments additional second, third, etc., sides can be coated with CVD diamond. In step 212A, ion substitution is used to chemically modify at least a second side of the glass substrate structure. The second side can be one of a top, bottom, edge, or corner. In step 214A, one or more processing steps that can include optional additional laminates (e.g. organic, polymer, inorganic, or graphene coatings) can be applied to at least one of a top, bottom, edge, or corner chemically modified glass substrate structure.

FIG. 2B is an exemplary block diagram of an embodiment of a method for fabricating a chemically modified glass substrate structure with one side being diamond coated such as illustrated with respect to FIG. 1B. In this embodiment, in a first step 212B, ion substitution is used to chemically modify at least a first and second side of the glass substrate structure. The second side can be one of a top, bottom, edge, or corner. In step 212B CVD diamond is formed on at least a first side. The first side can be one of a top, bottom, edge, or corner. In addition to a first side, in some embodiments additional second, third, etc., sides can be coated with CVD diamond. In step 214B, one or more processing steps that can include optional additional laminates (e.g. organic, polymer, inorganic, or graphene coatings) can be applied to at least one of a top, bottom, edge, or corner chemically modified glass substrate structure.

FIG. 2C is an exemplary block diagram of an embodiment of a method for fabricating a C structure with at least one side being diamond coated such as illustrated with respect to FIG. 1C. In this embodiment, in a first step 212C, ion substitution is used to chemically modify at least a first and second side of the glass substrate structure. The second side can be one of a top, bottom, edge, or corner. In step 212C CVD diamond is formed on at least a first side. The first side can be one of a top, bottom, edge, or corner. In addition to a first side, in some embodiments additional second, third, etc., sides can be coated with CVD diamond. In a step 214C, the chemically modified glass substrate structure can be placed in a second or multiple ion exchange bath for further chemical modification. In some embodiments, chemical modification by dopant implant through the CVD deposited diamond layer can be used to increase ion concentration or penetrance below the diamond. In step 216C, one or more processing steps that can include optional additional laminates (e.g. organic, polymer, inorganic, or graphene coatings) can be applied to at least one of a top, bottom, edge, or corner chemically modified glass substrate structure.

As will be understood, various types of glass substrates can be used in structures. For example, the glass can be a silicate glass, such as an alkali silicate glass, soda lime glass, an alkali aluminosilicate glass, an aluminosilicate glass, a borosilicate glass, an alkali aluminogermanate glass, an alkali germanate glass, an alkali gallogermanate glass, and combinations thereof. Structures can also be fabricated on infrared (IR) substrate materials including but not limited to Silicon (Si), Zinc Sulfide (ZnS), Zinc Selenide (ZnSe), Germanium (Ge), Magnesium Fluoride (MGF2), Sapphire (Al2O3), Aluminum Oxynitride (AlxOyNz), Spinel (MgAl2O4), Calcium Fluoride (CaF2), Sodium Chloride (NaCl). In some embodiments, multiple types of glass or IR materials can be fused or layered together to provide a substrate. Other examples of glass types and compositions suitable for use are described more fully in U.S. Pat. No. 8,232,218, assigned to Corning, Inc.

Glass substrate thickness can be less than 5 mm and, in some embodiments, have a thickness between 0.5 and 3 mm. In particularly thin embodiments, the thickness of the glass substrate can be between 0.3 and 1 mm. In some embodiments, thickness of a glass substrate can be between 0.25-3 mm. In other embodiments, thickness can be less than 2 mm, less than 1 mm, or less than 0.6 mm.

In one embodiment, forming glass substrate edges to correspond to a particular predetermined geometry and providing chemical modification can cause compression in the vicinity of the edges of the glass cover to be enhanced. The glass cover can thereby be made stronger by imposing the particular predetermined geometry on the edges of the glass cover. In one embodiment, surfaces, e.g., edges, of the glass cover can be chemically modified. In one embodiment, the edge geometry is configured to reduce or smooth out sharp transitions, such as corners.

In some embodiments one or more edges of the glass substrate can be curved or chamfered. A chamfer is a beveled edge that substantially connects two sides or surfaces (e.g., top and bottom surfaces). By way of example, edge geometry may include a chamfered edge of between 0.2 millimeter and 0.5 millimeters, extending at least partially between top and bottom sides of the glass substrate. Advantageously, use of the chamfered edge can reduce compressive stresses. Alternatively or in addition, in one embodiment, a glass substrate edge can include a smoothed corner, where for example a corner between a first surface and a second surface (e.g., top/bottom surface and a side surface that is substantially perpendicular) can be rendered less sharp. As another example, transition between a top surface to a side surface or between a bottom surface and a side surface can be smoothed. In some embodiments, edges of glass can be rounded by a predetermined edge geometry having a predetermined edge radius (or predetermined curvature) of at least 10% of the thickness applied to the corners of the edges of the glass. In other embodiments, the predetermined edge radius can be between 20% to 50% of the thickness of the glass. In one embodiment, a glass cover can extend to the edge of a housing of an electronic device without a protective bezel or other barrier. In one embodiment, the glass cover can include a bezel that surrounds the respective edges. The glass cover can be provided over or integrated with a display, such as a Liquid Crystal Display (LCD) display usable in a smartphone, watch, or tablet.

In some embodiments, a glass substrate structure can be subject to optional processing steps. Such processing steps can include applying one or more additional coatings or laminates (e.g., organic, polymer, inorganic, or graphene) to the glass substrate. In some embodiments, the entire substrate can have additional coatings, while in other embodiments at least one of a top, bottom, edge, or corner of the glass substrate can be provided with coatings.

In some embodiments, before deposition of a diamond or diamond like coating or film, a substrate can be treated by sputtering, evaporation, atomic layer deposition (ALD), chemical vapor deposition, plasma, thermal form of deposition of one or more of materials including but not limited to oxides and nitride dielectric materials, oxides of metals such as titanium, indium, tin, zinc, or combinations, oxides of graphene such as graphene oxide, reduced fluorinated graphene oxide, oxides of silicon, titanium, or aluminum, oxynitrides, nitrides of aluminum, silicon, titanium, boron, and metals such as tungsten or titanium. These intermediate materials can enable or enhance 1) adhesion of subsequent layers, 2) system optical properties such as transmission and reflection, 3) system stress through of thermal coefficient of enhancement transitioning, 4) reduced surface roughness, and other properties. In some embodiments, for metal deposited via sputter deposition, power levels can be adjusted, and shutter opening times can vary to achieve the target thickness uniformly across the display glass surface. For oxides and nitrides, thin films may utilize lower temperature (including temperatures less than or equal to 600° C.). Advantageously in some embodiments this can reduce coefficient of thermal expansion differences, reducing interlayer and subsurface stress, and allow for tuning coloration and visual uniformity, as well as optical losses attributable to haze or reflectance.

To encourage growth of diamond layers or films with selected grain sizes or in defined areas, a substrate can be seeded with diamond crystal particulates. Seed layers can be formed through the use of selective deposition or etched seed areas. In some embodiments, nanocrystalline diamonds can be directly deposited or deposited in a solution. In some embodiments, seed size can range from 5 to 50 nanometers. Seeds can be functionalized, or can have a positive, negative, or neutral zeta potential. The seed crystals may be in a solvent, dimethyl sulfoxide, oil, photoresist, deionized water, a combination or similar types of suspension or matrix. Substrate coverage with diamond crystal seeds can be uniformly distributed at 105-1013 grains per square centimeter, non-uniform, or localized in selected areas using masks, selective spraying, electrospraying, ultrasonic spraying, sonication, or other form of spatially localized application. In some embodiments seeds of differing sizes and characteristics can be used.

In some embodiments, a diamond layer formed on a diamond seeded substrate can have a sp2 concentration of less than 20% by diamond layer volume. In other embodiments, a diamond layer can have a grain orientation at least 80% in either the <111> or <100> crystalline direction. In still other embodiments, a highly oriented diamond film can include differing crystal orientations in selected region or layers, with <111> and <100> crystalline direction respectively predominating.

Properties of diamond can be measured and characterized using Raman spectroscopy. Cubic diamond has a single Raman-active first order phonon mode at the center of the Brillouin zone. The presence of sharp Raman lines allows cubic diamond to be recognized against a background of graphitic or other carbon crystal types. Small shifts in the band wavenumber can indicate diamond composition and properties. In some embodiments, the full width half maximum (FWHM) obtained from Raman characterization at a wave number of 1332 cm−1 for the diamond layers or films formed as indicated in this disclosure can be between 5 and 20 cm−1 for SiN or other suitable buffer layer coated glass and between 20 and 85 cm−1 for RIE (reactive ion etched) or other surface treated glass. In other embodiments, a deposited diamond layer can be measured to have a relative magnitude at 1332 cm−1 and greater than or equal to 0.5:1 as compared to magnitude at 1400-1600 cm−1 by Raman analysis. In other embodiments, a diamond layer can have physical properties such as Vickers hardness measured by nanoindentation of at least 12 Gigapascal. In other embodiments Vickers hardness can be greater than 20 Gigapascal. In other embodiments, a diamond layer can be measured to exert a compressive stress less than 50 Gigapascal.

In some embodiments, polycrystalline diamond or diamond-like carbon (DLC) coatings or materials can be formed on all or at least a portion of a substrate. In some embodiments, polycrystalline diamond grains sized to be less than 1 micron (1000 nanometers) and greater than 500 nanometers can be used. In other embodiments, polycrystalline diamond or diamond-like material can include ultrananocrystalline (UNCD) grain sizes (2-10 nanometers), nanocrystalline grain sizes (10-500 nanometers), or microcrystalline grain sizes (500 nanometers or greater). In some embodiments, diamond grain size can include a range of grain sizes, including larger and smaller grains. In some embodiments, a diamond layer can be formed to have grains of less than 1 micron. In some embodiments, grain size can differ by greater or less than 50%, 100%, 200% or 500% of mean diamond grain size. In other embodiments, diamond grain size can be maintained to within 50%, 20%, or 10% of mean grain size. In some embodiments, 50%, 60%, 80%, or 90% of the diamond grains can be sized between 50 and 500 nanometers. In some embodiments, a diamond layer can be formed from at least 90% nanocrystalline diamond and have diamond grains sized between 2 nanometers and 500 nanometers. In some embodiments, a diamond layer can be formed from at least 90% microcrystalline diamond and have diamond grains sized between 500 nanometers and 1000 nanometers. In other embodiments, diamond grains can be sized between 500 nanometers and 1000 nanometers. In other embodiments, 90% of the diamond grains can be sized between 200 and 300 nanometers.

Diamond layer thickness in some embodiments can be selected to be between 20 nanometers and 1000 nanometers. Typically diamond grain size will be 50% or less of diamond layer thickness. In some embodiments useful for optical coatings, diamond layer thickness will be between 20 and 500 nanometers. For example, in one embodiment a glass or other transparent material can be coated with a diamond film having a thickness between 100 and 300 nanometer thickness.

Diamond layers can have a substantially uniform thickness over all or defined portions of a surface or substrate. In other embodiments, thickness can be non-uniform, and vary over portions of a surface or substrate. In some embodiments diamond layers can be conformal when extending over cavities, depressions, or protrusions in a substrate or surface. In some embodiments, diamond layers can steadily thin or thicken away from one or more positions on a substrate.

Multiple diamond layers distinguished by composition, crystal structure, dopants, grain size, or grain size distribution can be a part of a multilayer coating or film system applied to a substrate. Distinct diamond layers can be layered on top of diamond layers or non-diamond materials. In certain embodiments, physical parameters of diamond layers can continuously or semi-continuously change vertically or laterally through the layer.

In particular embodiments, the diamond layer has a thickness, for example, between 30 nanometers and 150 nanometers (e.g., 30 nanometers, 40 nanometers, 50 nanometers, 60 nanometers, 70 nanometers, 80 nanometers, 90 nanometers, 100 nanometers, 110 nanometers, 120 nanometers, 130 nanometers, 140 nanometers, or 150 nanometers inclusive of all ranges and values there between). Furthermore, the diamond layer can have a root mean square (RMS) surface roughness of less than 2 nanometers

Diamond or DLC can be deposited by chemical vapor deposition (CVD) such as hot filament CVD, microwave CVD, rf-CVD, laser CVD (LCVD), or laser ablation, metal-organic CVD (MOCVD), sputtering, thermal evaporation PVD, ionized metal PVD (IMPVD), electron beam PVD (EBPVD), reactive PVD, cathodic arc, and the like. CVD involves the use of a diluted mixture of a carbon containing gas such as carbon dioxide or hydrocarbons, typically methane, and hydrogen whereby the carbon containing component content usually varies from about 0.1% to 4% of the total volumetric flow. In one of these techniques, the gas mixture is energized using a metallic filament, usually tungsten which is electrically heated to a temperature ranging from about 170° C. to 2400° C. The gas mixture disassociates at the filament surface and carbon, hybridized in the form of diamond, is deposited onto a substrate placed below the filament. In operation, power density at the substrate can be between 300-600 W/m2/min. Deposition usually occurs at sub-atmospheric pressures in the range of 30 mTorr to 300 Torr.

In some embodiments, a thin diamond film can be deposited on a substrate having a substrate temperature of less than 600 degrees Celsius. In other embodiments, deposition can be at temperatures between 300 and 600 degrees Celsius. Advantageously, as compared to typical 700-800 degree Celsius temperatures for conventional CVD mediated diamond film growth, such low temperatures greatly reduce thermal effects, including thermal degradation, stress due to differing CTE, or warping of the substrate. Advantageously, this can allow for a greater variety of substrates or coatings to be used.

In some embodiments, various processes can be used to improve diamond or other film quality. These processes can be done, for example, before seeding, before layer deposition, after layer deposition, or after metrology steps that contaminate the surface. For example, a substrate can be subjected to dry and/or wet processing, including but not limited to strong or weak acid and/or base cleaning, solvent cleaning, ultrasonic agitation, plasma cleaning, ultraviolet (UV), ozone treatment, application of tetramethyl ammonium hydroxide, or any other suitable combination of processes. Plasma cleaning can include subjecting a substrate to plasma derived from argon and/or oxygen in various concentrations. Post diamond deposition cleaning processes can be included such as: solvent clean that includes solvents such as: acetone and IPA, and plasma clean with O2/Ar gases using RIE or similar to clean the substrates to remove any unwanted residue deposited during the diamond deposition processes.

In some embodiments a glass or other substrate can support multiple thin diamond layers, various interlayers, layers pre-treated using reactive ion etching (RIE) or other techniques, and a top layer. These can be thin single or multiple layers of metals, ceramics, glasses, or other compositions. Thickness of such layers can be less than 1000 nanometers. Such layers can act as cap layers, intermediate layers, or buffer layers, and can improve optical, electrical, thermal, or mechanical properties of the multilayer structure. In some embodiments, cap, intermediate, or buffer layers can be transparent and include one or more of metals (e.g., tungsten or titanium); ceramics, dielectric materials, or glass (e.g., aluminosilicate or borosilicate). In some embodiments, cap layers, intermediate layers, or buffer layers can include one or more of indium tin oxide, aluminum oxide, oxynitrides, titanium oxides including but not limited to titanium dioxide, magnesium oxide, silicon dioxide, and hafnium oxide. In other embodiments, cap layers, intermediate layers, or buffer layers can include one or more of nitrides of aluminum, silicon, titanium, or boron. Cap layers, intermediate layers, or buffer layers can also include but are not limited to carbon film formed of diamond-like carbon (DLC), amorphous carbon or nano-crystal diamond (NCD), or a metal film made of molybdenum, titanium, tungsten, chromium or copper, or a ceramic film formed of SiC, TiC, CrC, WC, BN, B4C, Si3N4, TiN, CrN, SiCN, or BCN. The thickness of cap layers, intermediate layers, or buffer layers can range from 2 nanometers to 1000 nanometers.

In some embodiments, a deposited diamond film can be cleaned, and exposed to a two dimensional top layer material, such as reduced fluorinated graphene oxide, graphene, graphene oxide, or f-silane. In some embodiments this provides for superhydrophobicity or oleophobicity without significant degradation to diamond film properties, including optical transmissivity and/or hardness. In one embodiment, graphene oxide may come from a chemical suspension of multilayer graphene oxide and spun on to the diamond film, and either wet chemically or dry chemically (plasma) reduced through inclusion of fluorine atoms into the material, in substitution to oxygen.

In some embodiments, a substrate and/or diamond layer may be subjected to surface functionalization treatment steps. This can include surface functionalization by wet chemistry using spray coating, biased spray coating, ultrasonic spray coating, ultrasonic agitation of solvent and ketone mixtures, including but not limited to methanol, acetone, isopropyl alcohol, ethanol, butanol, or pentanol. The functionalized surface can include hydrocarbon chains, hydroxyl bonds, oxygen termination, or other suitable chemically active materials.

In some embodiments, a substrate and/or diamond layer may be subjected to surface functionalization treatment steps. This can include surface functionalization by wet chemistry using spray coating, biased spray coating, ultrasonic spray coating, ultrasonic agitation of solvent and ketone mixtures, including but not limited to methanol, acetone, isopropyl alcohol, ethanol, butanol, or pentanol. The functionalized surface can include hydrocarbon chains, hydroxyl bonds, oxygen termination, or other suitable chemically active materials.

In some embodiments, single or multiple diamond layers or films can include additional multilayer structures that enable or enhance various usages or features, including those that provide for light redirection, interference, cover glass, protective covers, displays, windows, chemical, thermal, or mechanical protection. Applications or components supporting multilayer diamond layers, films, or coatings can include but are not limited to visible or infrared optics, windows, optical waveguides, semiconductors, semiconductor coatings, and rugged or durable coatings for electronics, manufacturing, or tooling. Other applications for diamond multilayer coatings can include use in biological substrates or medical devices, or use in batteries, fuel cells, electrochemical systems, chemo-sensors, general sensing, or integration with other advanced materials.

As will be understood, the described diamond layers, substrates, and thin films of non-diamond materials can include various embodiments, characteristics, and combinations, including but not limited to the following additional examples:

Example 1—In a first example, a multilayer transparent diamond structure including nanocrystalline and ultrananocrystalline diamond layers can be continuously and conformally coated over a transparent glass substrate to act as an optically clear protective coating suitable for smart phones, tablets, or laptops. For example, a substantially uniform 70-110 nanometers thick nanocrystalline diamond film having a grain size ranging between 20 to 70 nanometers can be deposited on a conductive indium tin oxide (ITO) film that is deposited on the transparent glass substrate. In some embodiments, an ultrananocrystalline diamond layers having a thickness of between 20 and 500 nanometers with grain sizes between 2 and 10 nanometers can be deposited on the nanocrystalline diamond layer. In some embodiments, an ultrananocrystalline diamond layer can have a thickness of between 20 and 200 nanometers with diamond grain sizes between 2 and 10 nanometers. In some embodiments, an ultrananocrystalline diamond layer can have a thickness of less than 50 nanometers, with at least 50% of ultrananocrystalline diamond grains sized between 2 nanometers and 10 nanometers. Optionally a hydrophobic coating or additional diamond coating doped or functionalized to support a hydrophobic or oleophobic coating can be deposited on the ultrananocrystalline diamond layer. The glass substrate can be chemically cleaned using acetone, followed by cleaning using UV ozone. Alternatively, float glass or similar substrates can be acid cleaned to remove tin or other metallic coatings. In some embodiments the glass surface can be functionalized to include hydrocarbon chains derived from solvent breakdown while drying.

A conventional HF CVD reactor with tungsten, tantalum, or rhenium filaments can be used. Filament diameter, spacing, and number can be adjusted to provide best results. In one embodiment, filament diameter 0.12 to 0.5 mm, spacing can be 8 to 30 mm, and between 7 to 28 filaments used. Chambers can be spherical, rectangular, or cylindrical. In one embodiment, a cylindrical sphere can be sized to have a volume between 100 to 200 liters, with diameter between 30 to 150 centimeters.

The reactor can include a stage capable of supporting heating or cooling of the substrate. In some embodiments the reactor stage can be set to provide a substrate deposition temperature between 500 and 600 C. At these temperature ranges, diamond layer deposition rates can be between 10 to 100 nanometers per hour.

Precursor gases including methane, hydrogen, oxygen, and argon can be introduced into the chamber at a pressure of 10-15 Torr. In particular, addition of less than 1% oxygen can lower required temperature to maintain an expected deposition rate, and oxygen will preferentially etch sp2 deposited areas. Methane concentration can be between 0.5 to 5 percent of total gas volume. Hydrogen concentration can be between 60 to 90 percent of total gas volume. Argon concentration can be between 10 to 40 percent of total gas volume.

To ensure consistent grain size, the substrate can be coated with diamond seeds dispersed in a dimethyl sulfoxide (DMSO) or other solvent solutions including but limited to ethanol, methanol, IPA, and acetone. In some embodiments, 5 to 50 nanometer grain sizes can be used.

In some embodiments, the diamond film is continuous and conformal over the substrate.

Further, the diamond film can have a FWHM of 5-7 and an sp2 concentration of less than 20% by volume, a grain orientation of at least 80% in the <111> crystalline direction, a Raman spectrographic signature of diamond (approximately 1332 nm) of between 0.7:1 and 1.2:1 as compared to peak Graphitic Band (1400-1600 nm) by Raman Analysis, a Vickers hardness of between 20 and 60 Gigapascal, and with transmission of light through the glass substrate and the diamond film at 550 nanometer wavelength is in excess of 0.70, a haze of less than 5%.

Example 2—In a second example, a substrate can be coated with a substantially uniform 100-2000 nanometers thick nanocrystalline diamond layer or film having a grain size ranging between 100 to 2000 nanometers, as well as a thinner ultrananocrystalline diamond layer. In some embodiments, an optional ultrananocrystalline diamond layer can be deposited that can have a thickness of between 20 and 200 nanometers with grain sizes between 2 and 10 nanometers. In some embodiments, ultrananocrystalline diamond layers can have a thickness of less than 50 nanometers, with at least 50% of ultrananocrystalline diamond grains sized between 2 nanometers and 10 nanometers. In one embodiment, the 100-2000 nanometers thick nanocrystalline diamond film and optional covering ultrananocrystalline diamond layer and can be further etched, with additional layers or films being selectively applied to fill in etched diamond and support formation of waveguides for data transfer. In some embodiments, the deposited grain size can include diamond grains ranging from 5 nanometers to 50 nanometers. The reactor can include a stage capable of supporting heating or cooling of the substrate. In some embodiments the reactor stage can be set to provide a substrate deposition temperature between 500 and 800 C. At these temperature ranges, diamond layer deposition rates can be between 10 to 200 nanometers per hour, or in other embodiments can be less than 10 nm per hour.

The substrate can be coated with diamond seeds dispersed in a DMSO or other solvent solutions including but limited to ethanol, methanol, IPA, and acetone. In some embodiments, 5 to 15,000 nanometer grain sizes can be used, with larger grains typically being reduceable in size by sonication or other processing steps. Various grain sizes or grain size ranges can be used in some embodiments, including co-deposited small and large grain sizes. In some embodiments, the seeds are deposited in a manner that ensures that the film is continuous and conformal over the substrate.

In some embodiments, the diamond layer or film can have a Young's modulus in excess of 80 Gigapascal.

Example 3—In a third example, a substrate can be coated with multiple layers, including diamond layers, ceramic layers, or metal layers. In some embodiments, a substantially uniform 5-50 nanometers thick nanocrystalline diamond layer or film having a grain size ranging between 5 to 50 nanometers can be deposited. In some embodiments, an optional ultrananocrystalline diamond layer can be deposited that can have a thickness of between 20 and 200 nanometers with grain sizes between 2 and 10 nanometers. In some embodiments, optional ultrananocrystalline diamond layers can have a thickness of less than 50 nanometers, with at least 50% of ultrananocrystalline diamond grains sized between 2 nanometers and 10 nanometers.

The reactor can include a stage capable of supporting heating or cooling of the substrate. In some embodiments the reactor stage can be set to provide a substrate deposition temperature between 500 and 600 C. At these temperature ranges, diamond layer deposition rates can be between 10 to 100 nanometers per hour.

In the foregoing description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The foregoing detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

We claim:

1. A diamond coated glass structure, comprising:
a glass substrate having a first and a second side, wherein the second side is chemically modified through ion substitution; and
a CVD deposited diamond layer on the first side.

2. The structure of claim 1, wherein the CVD deposited diamond layer comprises less than 20% SP2 carbon.

3. The structure of claim 1, wherein the CVD deposited diamond layer comprises multiple diamond layers.

4. The structure of claim 1, wherein the CVD deposited diamond layer comprises an ultrananocrystalline diamond layer on a nanocrystalline diamond layer.

5. The structure of claim 1, wherein the substrate has a dimension of at least one centimeter.

6. The structure of claim 1, wherein ion substitution further comprises replacement of at least some sodium ions with potassium ions.

7. The structure of claim 1, wherein ion substitution further comprises replacement of at least some ions on the second side to a penetration depth of less than 100 microns.

8. A diamond coated glass structure, comprising:
a glass substrate having a first and a second side, wherein the first and the second side are chemically modified through ion substitution and penetration depth differs between the first and second sides; and
a CVD deposited diamond layer on at least one of the first side and the second side.

9. The structure of claim 8, wherein the CVD deposited diamond layer comprises multiple diamond layers.

10. The structure of claim 8, wherein the CVD deposited diamond layer comprises an ultrananocrystalline diamond layer on a nanocrystalline diamond layer.

11. The structure of claim 8, wherein ion substitution further comprises replacement of at least some sodium ions with potassium ions.

12. The structure of claim 8, wherein ion substitution further comprises replacement of at least some ions on the second side to a penetration depth of less than 100 microns.

13. A diamond coated glass structure, comprising:
a glass substrate having an opposing first and a second side and four edges, wherein the first and the second side and four edges are chemically modified through ion substitution, and wherein penetration depth of the first side differs from at least one of the second side and the four edges; and
a CVD deposited diamond layer on the first side.

14. The structure of claim 13, wherein the CVD deposited diamond layer comprises multiple diamond layers.

15. The structure of claim 13, wherein the CVD deposited diamond layer comprises an ultrananocrystalline diamond layer on a nanocrystalline diamond layer.

16. The structure of claim 13, wherein the substrate has a dimension of at least one centimeter.

17. The structure of claim 13, wherein ion substitution further comprises replacement of at least some sodium ions with potassium ions.

18. The structure of claim 13, wherein ion substitution further comprises replacement of at least some ions on the second side to a penetration depth of less than 100 microns.

19. A method of forming a diamond coated glass structure, comprising:
providing a glass substrate having a first and a second side;
CVD depositing a diamond layer on the first side; and
after CVD diamond deposition, chemically modifying the second side through ion substitution.

20. The method of forming a diamond coated glass structure of claim 19, wherein the first side of the glass substrate is chemically modified.

21. A method of forming a diamond coated glass structure, comprising:
providing a glass substrate having a first and a second side;
chemically modifying for a first time the first and second sides through ion substitution;
CVD depositing a diamond layer on the first side; and
after CVD diamond deposition, for a second time chemically modifying both the first and second side through ion substitution.

22. A method of forming a diamond coated glass structure, comprising:
providing a glass substrate having a first and a second side;
chemically modifying for a first time the first and second sides through ion substitution;
CVD depositing a diamond layer on the first side; and
after CVD diamond deposition, for a second time chemically modifying only the second side through ion substitution.
